(19) United States
(12) Patent Application Publication
(10) Pub. No.: US 2021/0389518 A1
(43) Pub. Date: Dec. 16, 2021

(54) LIGHT FLUX CONTROLLING MEMBER, LIGHT-EMITTING DEVICE, SURFACE LIGHT SOURCE DEVICE, AND DISPLAY DEVICE

(71) Applicant: Enplas Corporation, Saitama (JP)

(72) Inventor: Kensuke HIRAKA, Saitama (JP)

(21) Appl. No.: 17/281,604

(22) PCT Filed: Sep. 27, 2019
(86) PCT No.: PCT/JP2019/038214

§ 371 Date: Mar. 31, 2021

(30) Foreign Application Priority Data
Oct. 1, 2018 (JP) 2018-186488

(51) Int. Cl. F21V 8/00; G02B 3/08

(52) U.S. Cl. CPC G02B 6/0051; G02B 6/0055; G02B 6/0073; G02B 6/0068; G02B 3/08

(57) ABSTRACT

The light flux controlling member according to the present invention comprises: an incident surface which is disposed on the back side so as to intersect with a central axis of a light flux controlling member, and on which a part of the light emitted from a light-emitting element falls; a reflection portion arranged on the back side so as to surround the incident surface; a total reflection surface that is disposed on the front side so as to intersect with the central axis, and reflects sidewise the light incident on the incident surface; and an emission surface that is disposed so as to surround the central axis and the total reflection surface and emits light reflected by the total reflection surface. The reflection portion has a plurality of ridges for reflecting light that has reached the reflection portion after Fresnel reflection on the emission surface.

### TECHNICAL FIELD

The present invention relates to a light flux controlling member that controls the distribution of light emitted from a light-emitting element. The present invention also relates to a light-emitting device including the light flux controlling member, a surface light source device including the light-emitting device, and a display device including the surface light source device.

### BACKGROUND ART

Transmission image display devices such as liquid crystal display apparatuses use a direct surface light source device as a backlight in some cases. In recent years, a direct surface light source device including a plurality of light-emitting elements as the light source is used (see, for example, PTL 1).

FIGS. 1A and 1B illustrate a configuration of surface light source device 10 disclosed in PTL 1. FIG. 1A is a perspective view of surface light source device 10, and FIG. 1B is a partially enlarged sectional view of surface light source device 10. Note that in FIG. 1A, a part of light diffusion member 15 is omitted to illustrate the interior.

As illustrated in the drawings, surface light source device 10 includes housing 11, support plate 12 disposed in housing 11, a plurality of mounting boards 13 fixed to support plate 12, a plurality of light source units 14 fixed to mounting boards 13, and light diffusion member 15 disposed at the opening of housing 11. The surfaces of support plate 12 and mounting board 13 are painted white for light reflection. Light source unit 14 includes LED 16 and optical element 20 that controls the distribution of emission light of LED 16, and light source unit 14 is fixed to mounting board 13 with spacer 17 therebetween.

Optical element 20 includes planar incidence surface 21 formed on the rear side, bell-shaped reflecting surface 22 formed on the front side, and side surface 23 formed to connect the outer edge of incidence surface 21 and the outer edge of reflecting surface 22. The emission light of LED 16 enters optical element 20 from incidence surface 21, and is reflected at reflecting surface 22 toward side surface 23. The reflected light is emitted to the outside of optical element 20 from light side surface 23. A part of the light emitted from side surface 23 travels toward light diffusion member 15, and another part of the light emitted from side surface 23 travels toward support plate 12 or mounting board 13. The light having reached support plate 12 or mounting board 13 is reflected at the surface of support plate 12 or mounting board 13 while being diffused. The light having reached light diffusion member 15 from side surface 23 and the light having reached light diffusion member 15 from support plate 12 or mounting board 13 are transmitted through light diffusion member 15 while being diffused.

### CITATION LIST

### Patent Literature

### PTL 1

### Japanese Patent Application Laid-Open No. 2007-048883

### SUMMARY OF INVENTION

### Technical Problem

In optical element 20 disclosed in PTL 1, a part of the light having reached side surface (emission surface) 23 is reflected (Fresnel-reflected) at side surface 23 so as to reach the rear surface (incidence surface 21) of optical element (light flux controlling member) 20. If the light having reached incidence surface 21 is reflected at incidence surface 21, the reflected light travels to the region immediately above optical element 20, thus causing luminance unevenness. In addition, if the light having reached incidence surface 21 is transmitted through incidence surface 21, the transmitted light is absorbed by spacer 17, resulting in a large light loss. The situation where the light reflected at side surface (emission surface) 23 travels toward the region immediately above optical element (light flux controlling member) 20 and the situation where that light is absorbed are not preferable.

In view of the above, an object of the present invention is to provide a light flux controlling member that controls the distribution of light emitted from a light-emitting element, and can efficiently utilize light reflected by an emission surface while suppressing generation of luminance unevenness. Another object of the present invention is to provide a light-emitting device, a surface light source device and a display device that include the light flux controlling member.

### Solution to Problem

A light flux controlling member according to an embodiment of the present invention is configured to control a distribution of light emitted from a light-emitting element, the light flux controlling member including: an incidence surface disposed on a rear side of the light flux controlling member to intersect a central axis of the light flux controlling member, the incidence surface being configured to allow incidence of a part of the light emitted from the light-emitting element; a reflection part disposed on the rear side to surround the incidence surface; a total reflection surface disposed on a front side of the light flux controlling member to intersect the central axis and configured to reflect, toward a lateral side of the light flux controlling member, light entered from the incidence surface; and an emission surface disposed to surround the central axis and the total reflection surface and configured to emit light reflected at the total reflection surface. The reflection part includes a plurality of ridges configured to reflect light having reached the reflection part after being Fresnel-reflected at the emission surface, and the plurality of ridges includes a first reflecting surface, a second reflecting surface and a ridgeline that is a line of intersection of the first reflecting surface and the second reflecting surface.

A light-emitting device according to an embodiment of the present invention includes: a light-emitting element; and the light flux controlling member.

A surface light source device according to an embodiment of the present invention includes: the light-emitting device; and a light diffusion member configured to transmit light from the light-emitting device while diffusing the light.

A display device according to an embodiment of the present invention includes: the surface light source device; and a display member configured to be illuminated with light emitted from the surface light source device.

### Advantageous Effects of Invention

A surface light source device including the light flux controlling member according to an embodiment the present invention can illuminate the illuminated surface with light more uniformly with higher efficiency in comparison with a surface light source device including a known light flux controlling member. Thus, the surface light source device and the display device according to an embodiment of the present invention are brighter with less luminance unevenness.

### BRIEF DESCRIPTION OF DRAWINGS

FIGS. 1A and 1B illustrate a configuration of a surface light source device disclosed in PTL 1;

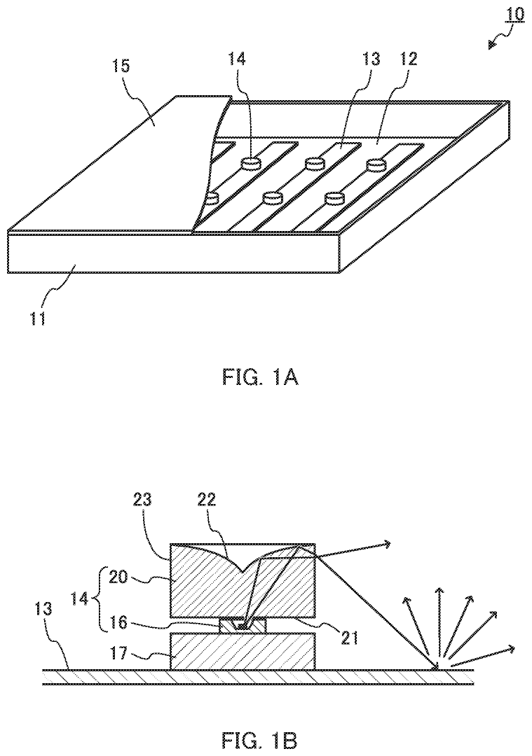

FIGS. 2A and 2B illustrate a configuration of surface light source devices according to Embodiments 1 and 2;

FIGS. 3A and 3B are sectional views illustrating a configuration of the surface light source devices according to Embodiments 1 and 2;

FIG. 4 is a partially enlarged sectional view of FIG. 3B;

FIGS. 5A to 5D illustrate a configuration of a light flux controlling member according to Embodiment 1;

FIGS. 6A to 6D illustrate a configuration of a light flux controlling member according to Embodiment 2;

FIGS. 7A to 7D illustrate a configuration of a light flux controlling member according to a comparative example; and

FIG. 8 is a graph showing light distribution characteristics of each light flux controlling member.

### DESCRIPTION OF EMBODIMENTS

Embodiments of the present invention are elaborated below with reference to the accompanying drawings.

### Embodiment 1

### Configurations of Surface Light Source Device and Light-Emitting Device

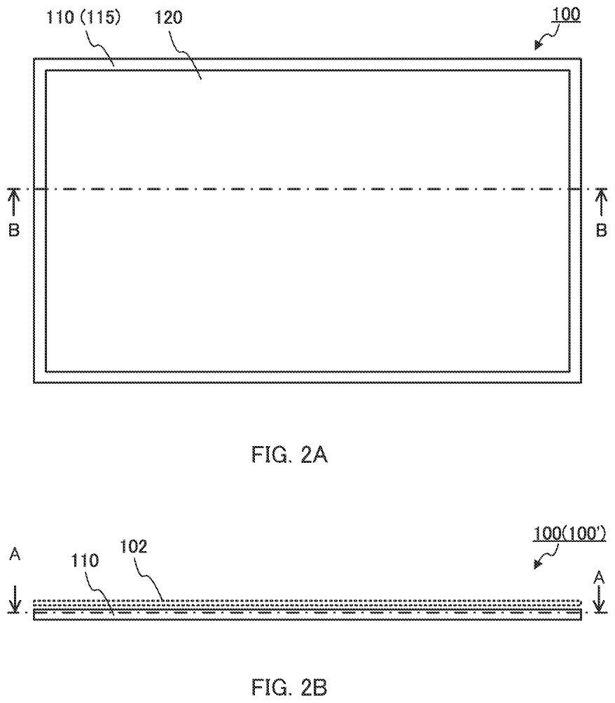

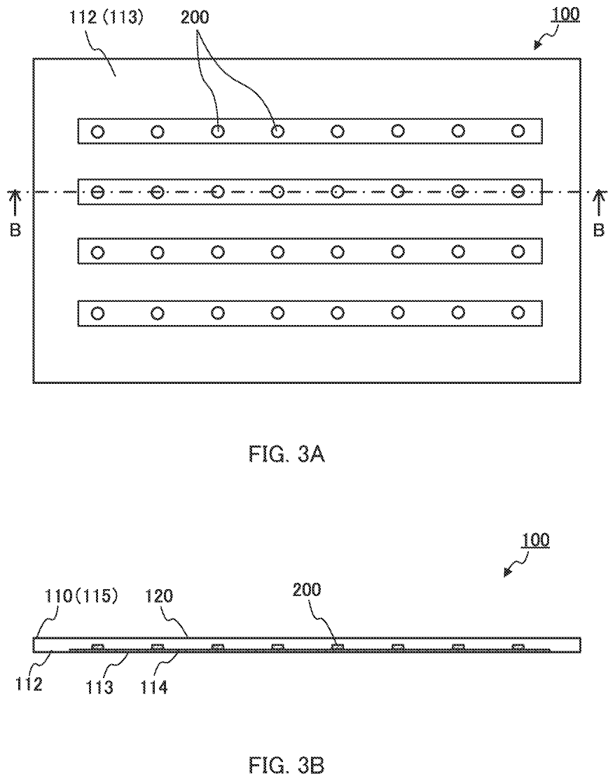

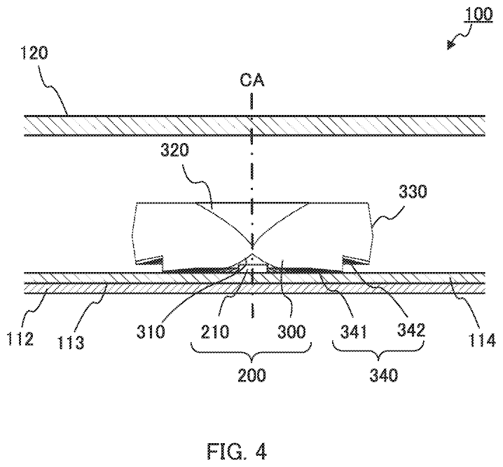

FIGS. 2A to 4 illustrate a configuration of surface light source device 100 according to Embodiment 1 of the present invention. FIG. 2A is a plan view of surface light source device 100, and FIG. 2B is a front view of surface light source device 100. FIG. 3A is a sectional view taken along line A-A of FIG. 2B, and FIG. 3B is a sectional view taken along line B-B of FIG. 2A. FIG. 4 is a partially enlarged sectional view of FIG. 3B.

As illustrated in FIGS. 2A to 3B, surface light source device 100 according to the present embodiment includes housing 110, a plurality of light-emitting devices 200 and light diffusion member 120. In addition, as illustrated in FIG. 2B, surface light source device 100 can be used as display device 100′ when used with a display member (illumination target member) 102 (illustrated with the broken line in FIG. 2B) such as a liquid crystal panel.

As illustrated in FIG. 3A, the plurality of light-emitting devices 200 is disposed in a matrix on inner surface 113 of bottom plate 112 of housing 110. Here, inner surface 113 of bottom plate 112 functions as a diffusive reflection surface. In addition, an opening is provided in top plate 115 of housing 110. Light diffusion member 120 closes the opening and functions as a light-emitting surface. The size of the light-emitting surface is not limited, but is, for example, approximately 400 mm×approximately 700 mm.

As illustrated in FIG. 4, in each of the plurality of light-emitting devices 200, a leg part (not illustrated) formed on the rear side of light flux controlling member 300 is fixed to substrate 114 disposed on inner surface 113 of bottom plate 112. Each of the plurality of light-emitting devices 200 includes light-emitting element 210 and light flux controlling member 300. The position and number of the leg part may be freely set as long as the optical influence on the light-emitting surface of surface light source device 100 can be minimized and stable fixing to substrate 114 can be achieved.

Light-emitting element 210 is a light source of surface light source device 100. Light-emitting element 210 is, for example, a light-emitting diode (LED) such as a white light-emitting diode.

Light flux controlling member 300 controls the distribution of light emitted from light-emitting element 210. Note that in the present embodiment, each of incidence surface 310, reflection part 340, total reflection surface 320 and emission surface 330 of light flux controlling member 300 is rotationally symmetrical, and their rotational axes coincide with each other. In the present embodiment, the rotational axis is referred to as “central axis CA of light flux controlling member”.

Light flux controlling member 300 is formed by integral shaping. The material of light flux controlling member 300 is not limited as long as light of the desired wavelength can pass therethrough. Examples of the material of light flux controlling member 300 include optically transparent resins such as polymethylmethacrylate (PMMA), polycarbonate (PC), and epoxy resin (EP), and glass.

One of the features of surface light source device 100 according to the present embodiment is the configuration of light flux controlling member 300. Therefore, light flux controlling member 300 will be separately elaborated later.

Light diffusion member 120 is a plate-shaped member having light diffusibility, and transmits light emitted from light-emitting device 200 while diffusing the light. Normally, the size of light diffusion member 120 is substantially the same as the size of an illumination target member such as a liquid crystal panel. For example, light diffusion member 120 is formed with optically transparent resins such as polymethylmethacrylate (PMMA), polycarbonate (PC), polystyrene (PS), and styrene methyl methacrylate copolymerization resin (MS). Known examples of light diffusion member 120 include one in which minute irregularities are formed in the surface of light diffusion member 120 and one in which light diffusers such as beads are dispersed in light diffusion member 120, for the purpose of providing light diffusibility.

### Configuration of Light Flux Controlling Member

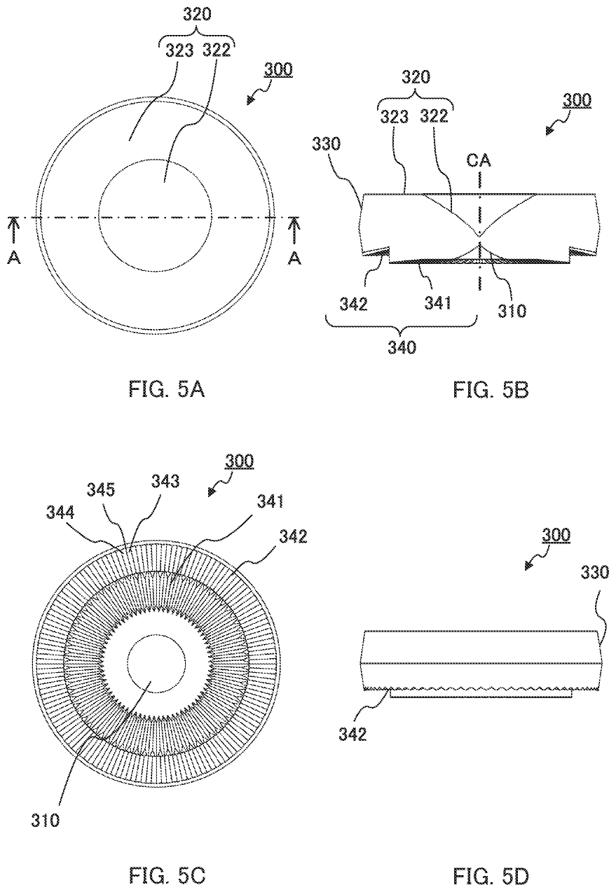

FIGS. 5A to 5D illustrate a configuration of light flux controlling member 300 according to the present embodiment. FIG. 5A is a plan view of light flux controlling member 300. FIG. 5B is a sectional view taken along line A-A of FIG. 5A. FIG. 5C is a bottom view of light flux controlling member 300. FIG. 5D is a front view of light flux controlling member 300. Note that hatching is omitted in FIG. 5B.

As illustrated in FIGS. 5A to 5D, light flux controlling member 300 includes incidence surface 310 disposed on the rear side to intersect central axis CA of light flux controlling member 300, reflection part 340 disposed on the rear side to surround incidence surface 310, total reflection surface 320 disposed on the front side to intersect central axis CA, and emission surface 330 disposed to surround central axis CA and total reflection surface 320. Here, the “front side” means the light diffusion member 120 side, and the “rear side” means the bottom plate 112 side (light-emitting element 210 side).

Incidence surface 310 is the inner surface of a recess of a substantially triangular pyramidal shape disposed on the rear side to intersect central axis CA of light flux controlling member 300. In addition, incidence surface 310 allows the light emitted from light-emitting element 210 to enter light flux controlling member 300. Incidence surface 310 is configured such that most of the incident light travels toward total reflection surface 320.

Total reflection surface 320 is disposed on the front side to intersect central axis CA, and reflects, toward the lateral side (emission surface 330 side), the light entered from incidence surface 310. In the present embodiment, total reflection surface 320 includes first total reflection surface 322 disposed at a position facing incidence surface 310, and second total reflection surface 323 disposed to surround first total reflection surface 322. First total reflection surface 322 is the inner surface of a recess of a substantially triangular pyramidal shape formed to have the apex at a position opposite to the apex of incidence surface 310. Second total reflection surface 323 is an annular flat surface.

Emission surface 330 is disposed to surround central axis CA and total reflection surface 320. Emission surface 330 is a side surface that connects the outer edge of the rear surface of light flux controlling member 300 and the outer edge of the front surface. Emission surface 330 emits, toward the lateral side (the direction away from central axis CA of light flux controlling member 300), the light reflected by total reflection surface 320. At this time, a part of the light having reached emission surface 330 is internally reflected toward reflection part 340.

Reflection part 340, which is disposed on the rear side of light flux controlling member 300 as with incidence surface 310, further internally reflects the light that reaches reflection part 340 after being internally reflected by emission surface 330. In the present embodiment, reflection part 340 includes first reflection part 341 disposed at a position surrounding incidence surface 310, and second reflection part 342 disposed to surround first reflection part 341. Reflection part 340 (first reflection part 341 and second reflection part 342) includes a plurality of ridges for reflecting the light arriving from emission surface 330. Each of the plurality of ridges includes first reflecting surface 343, second reflecting surface 344, and ridgeline 345 that is the line of intersection of first reflecting surface 343 and second reflecting surface 344, and each of the plurality of ridges functions as a total reflection prism. Each ridge has a substantially triangular cross-sectional shape.

In the present embodiment, in each of first reflection part 341 and second reflection part 342, the plurality of ridges is disposed such that the extension of ridgeline 345 intersects central axis CA and that ridgeline 345 goes toward the front side as it goes toward central axis CA. The inclination angle of the each ridge (ridgeline) in first reflection part 341 is not limited, but preferably is approximately 0 to 10° with respect to bottom plate 112 from the viewpoint of preventing the incident light from being reflected immediately above and preventing the incident light from being transmitted therethrough. Also, the inclination angle of each ridge (ridgeline) in second reflection part 342 is not limited, but preferably is approximately 5 to 15° with respect to bottom plate 112 from the viewpoint of preventing the incident light from being reflected immediately above and preventing the incident light from being transmitted therethrough.

### Light Paths in Surface Light Source Device

In surface light source device 100 according to the present embodiment, the distribution of light emitted from light-emitting element 210 in each light-emitting device 200 is controlled by light flux controlling member 300. In each light-emitting device 200, the light emitted from light-emitting element 210 reaches emission surface 330 after being transmitted through incidence surface 310 and reflected by total reflection surface 320. Most of the light having reached emission surface 330 is emitted to the lateral side from emission surface 330. On the other hand, a part of the light having reached emission surface 330 reaches reflection part 340 (first reflection part 341 or second reflection part 342) after being internally reflected at emission surface 330. The light having reached reflection part 340 is internally reflected toward the lateral side, not immediately above, at the ridge that functions as a total reflection prism, and then emitted to the lateral side from emission surface 330 or the like. The light of each light-emitting device 200 emitted to the lateral side from light flux controlling member 300 reaches light diffusion member 120 after being diffused and reflected at inner surface 113 of bottom plate 112, or directly reaches light diffusion member 120. Light diffusion member 120 transmits the light emitted from light-emitting device 200 while diffusing the light.

### Effect

As described above, in surface light source device 100 according to the present embodiment, light flux controlling member 300 includes reflection part 340 that further internally reflects the light internally reflected at emission surface 330. As a result, the light internally reflected at emission surface 330 is not reflected immediately above the rear surface of light flux controlling member 300, and the light internally reflected at emission surface 330 is not transmitted through the rear surface of light flux controlling member 300 and absorbed by inner surface 113 of bottom plate 112. Thus, surface light source device 100 including light flux controlling member 300 according to the present embodiment can illuminate the illuminated surface with light more uniformly with higher efficiency in comparison with a surface light source device including a known light flux controlling member. Thus, surface light source device 100 and display device 100′ according to the present embodiment are brighter with less luminance unevenness in comparison with a known apparatus.

### Embodiment 2

### Configurations of Surface Light Source Device and Light-Emitting Device

A surface light source device according to Embodiment 2 differs from surface light source device 100 according to Embodiment 1 only in that light flux controlling member 400 according to Embodiment 2 is provided in place of light flux controlling member 300 according to Embodiment 1. In view of this, in the present embodiment, only light flux controlling member 400 according to Embodiment 2 is described.

### Configuration of Light Flux Controlling Member

Light flux controlling member 400 according to Embodiment 2 differs from light flux controlling member 300 according to Embodiment 1 only in the shape of reflection part 410. In view of this, the same configurations as those of light flux controlling member 300 according to Embodiment 1 are denoted with the same reference numerals, and the description thereof will be omitted.

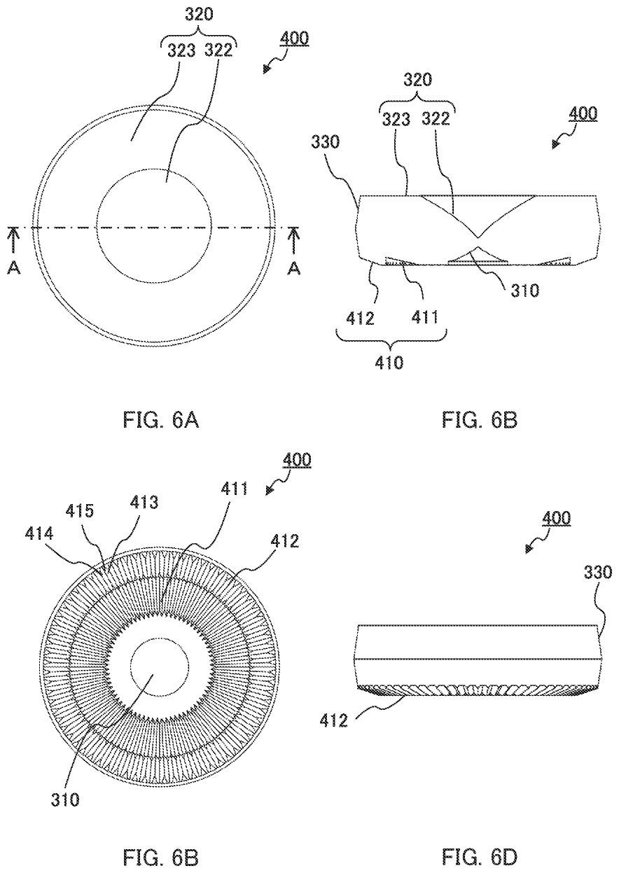

FIGS. 6A to 6D illustrate a configuration of light flux controlling member 400 according to the present embodiment. FIG. 6A is a plan view of light flux controlling member 400. FIG. 6B is a sectional view taken along line A-A of FIG. 6A. FIG. 6C is a bottom view of light flux controlling member 400. FIG. 6D is a front view of light flux controlling member 400. Note that in FIG. 6B, hatching is omitted.

As illustrated in FIGS. 6A to 6D, light flux controlling member 400 includes incidence surface 310 disposed on the rear side to intersect central axis CA of light flux controlling member 400, reflection part 410 disposed on the rear side to surround incidence surface 310, total reflection surface 320 disposed on the front side to intersect central axis CA, and emission surface 330 disposed to surround central axis CA and total reflection surface 320.

Reflection part 410, which is disposed on the rear side of light flux controlling member 400 as with incidence surface 310, further internally reflects the light having reached reflection part 410 after being internally reflected at emission surface 330. In the present embodiment, reflection part 410 includes first reflection part 411 disposed at a position surrounding incidence surface 310, and second reflection part 412 disposed to surround first reflection part 411. Reflection part 410 (first reflection part 411 and second reflection part 412) includes a plurality of ridges for reflecting the light arriving from emission surface 330. Each of the plurality of ridges includes first reflecting surface 413, second reflecting surface 414, and ridgeline 415 that is a line of intersection of first reflecting surface 413 and second reflecting surface 414, and each of the plurality of ridges functions as a total reflection prism. Each ridge has a substantially triangular cross-sectional shape.

In the present embodiment, in each of first reflection part 411 and second reflection part 412, the plurality of ridges is disposed such that the extension of ridgeline 415 intersects central axis CA and that ridgeline 415 goes toward the rear side as it goes toward central axis CA. The inclination angle of each ridge (ridgeline) in the first reflection part 411 is not limited, but preferably is approximately 75 to 85° with respect to bottom plate 112 from the viewpoint of preventing the incident light from being reflected immediately above and preventing the incident light from being transmitted therethrough. Also, the inclination angle of each ridge (ridgeline) in second reflection part 412 is not limited, but preferably is approximately 70 to 80° with respect to bottom plate 112 from the viewpoint of preventing the incident light from being reflected immediately above and preventing the incident light from being transmitted therethrough.

### Light Paths in Surface Light Source Device

In the surface light source device according to the present embodiment, as in surface light source device 100 according to Embodiment 1, the distribution of the light emitted from light-emitting element 210 in each light-emitting device is controlled by light flux controlling member 400. In each light-emitting device, the light emitted from light-emitting element 210 reaches emission surface 330 after being transmitted through incidence surface 310 and reflected by total reflection surface 320. Most of the light having reached emission surface 330 is emitted to the lateral side from emission surface 330. On the other hand, a part of the light having reached emission surface 330 reaches reflection part 410 (first reflection part 411 or second reflection part 412) after being internally reflected at emission surface 330. The light having reached reflection part 410 is internally reflected, toward the lateral side, not immediately above, at the ridge that functions as a total reflection prism and is emitted to the lateral side from emission surface 330 or the like. The light emitted to the lateral side from light flux controlling member 400 of each light-emitting device reaches light diffusion member 120 after being diffused and reflected at inner surface 113 of bottom plate 112, or directly reaches light diffusion member 120. Light diffusion member 120 transmits the light emitted from the light-emitting device while diffusing the light.

### Effect

The surface light source device according to the present embodiment has an effect similar to that of surface light source device 100 according to Embodiment 1.

### Comparison of Illuminance Distribution

To check the effects of light flux controlling member 300 of Embodiment 1 and light flux controlling member 400 of Embodiment 2, the illuminance distribution of one light-emitting device on light diffusion member 120 was measured using surface light source device 100 of Embodiment 1 and the surface light source device of Embodiment 2. For comparison, the illuminance distribution of one light-emitting device on light diffusion member 120 was measured also using a surface light source device including light flux controlling member 500 according to a comparative example that does not include reflection part 340 or 410.

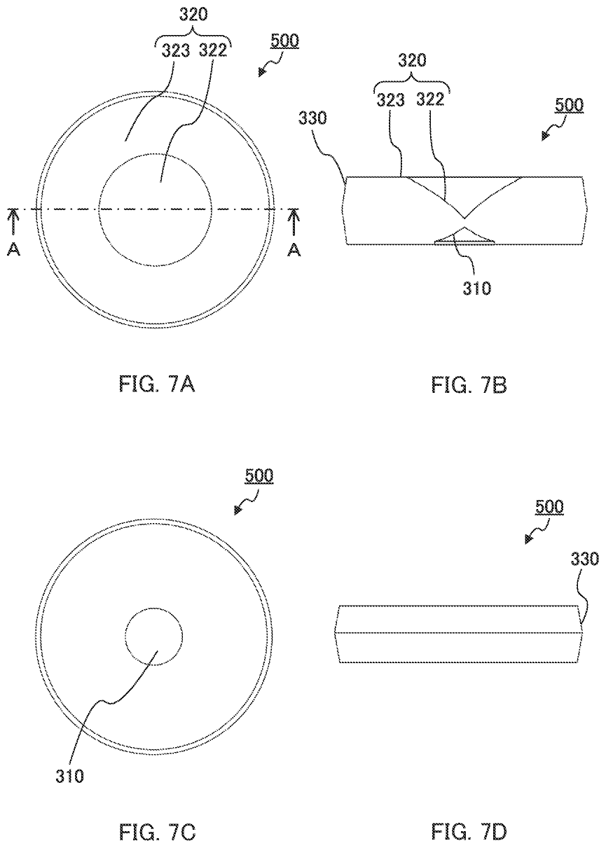

FIGS. 7A to 7D illustrate a configuration of light flux controlling member 500 according to the comparative example. FIG. 7A is a plan view of light flux controlling member 500. FIG. 7B is a sectional view taken along line A-A of FIG. 7A. FIG. 7C is a bottom view of light flux controlling member 500. FIG. 7D is a front view of light flux controlling member 500. Note that in FIG. 7B, hatching is omitted. As illustrated in FIGS. 7A to 7D, light flux controlling member 500 according to the comparative example differs from light flux controlling member 300 of Embodiment 1 and light flux controlling member 400 of Embodiment 2 only in that it is not provided with reflection parts 340 or 410.

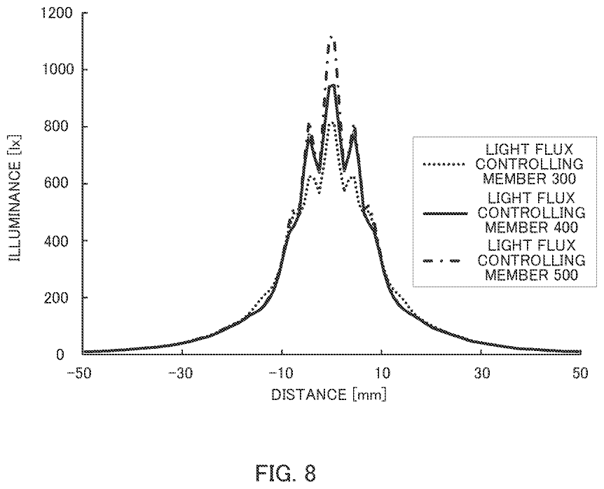

FIG. 8 is a graph showing illuminance distributions on light diffusion members 120 of light flux controlling member 300 of Embodiment 1, light flux controlling member 400 of Embodiment 2 and light flux controlling member 500 according to the comparative example. The abscissa indicates the distance from central axis CA of the light flux controlling member, and the ordinate indicates the illuminance (lx).

FIG. 8 shows that with light flux controlling member 300 of Embodiment 1 or light flux controlling member 400 of Embodiment 2, generation of bright spots in a region immediately above the light flux controlling member can be suppressed in comparison with the case where light flux controlling member 500 according to the comparative example is used. That is, it is shown that with light flux controlling member 300 of Embodiment 1 or light flux controlling member 400 of Embodiment 2, the luminance unevenness of the surface light source device can be reduced in comparison with the case where light flux controlling member 500 according to the comparative example is used.

This application is entitled to and claims the benefit of Japanese Patent Application No. 2018-186488 filed on Oct. 1, 2018, the disclosure each of which including the specification, drawings and abstract is incorporated herein by reference in its entirety.

### INDUSTRIAL APPLICABILITY

The light flux controlling member, the light-emitting device, the surface light source device and the display device according to the present invention are applicable to, for example, a backlight of a liquid crystal display apparatus and a generally-used illumination apparatus.

### REFERENCE SIGNS LIST

10 Surface light source device
11 Housing
12 Support plate
13 Mounting board
14 Light source unit
15 Light diffusion member
16 LED
17 Spacer
20 Optical element
21 Incidence surface
22 Reflecting surface
23 Side surface
100 Surface light source device
100′ Display device
102 Display member (Illumination target member)
110 Housing
112 Bottom plate
113 Inner surface (Diffusive reflection surface)
114 Substrate
115 Top plate
120 Light diffusion member (Light-emitting surface)
200 Light-emitting device
210 Light-emitting element
300, 400, 500 Light flux controlling member
310 Incidence surface
320 Total reflection surface
322 First total reflection surface
323 Second total reflection surface
330 Emission surface
340, 410 Reflection part
341, 411 First reflection part
342, 412 Second reflection part
343, 413 First reflecting surface
344, 414 Second reflecting surface
345, 415 Ridgeline
CA Central axis of light flux controlling member

1. A light flux controlling member configured to control a distribution of light emitted from a light-emitting element, the light flux controlling member comprising:
an incidence surface disposed on a rear side of the light flux controlling member to intersect a central axis of the light flux controlling member, the incidence surface being configured to allow incidence of a part of the light emitted from the light-emitting element;
a reflection part disposed on the rear side to surround the incidence surface;
a total reflection surface disposed on a front side of the light flux controlling member to intersect the central axis and configured to reflect, toward a lateral side of the light flux controlling member, light entered from the incidence surface; and
an emission surface disposed to surround the central axis and the total reflection surface and configured to emit light reflected at the total reflection surface,
wherein the reflection part includes a plurality of ridges configured to reflect light having reached the reflection part after being Fresnel-reflected at the emission surface, and
wherein the plurality of ridges includes a first reflecting surface, a second reflecting surface and a ridgeline that is a line of intersection of the first reflecting surface and the second reflecting surface.

2. The light flux controlling member according to claim 1, wherein the plurality of ridges is disposed such that an extension of the ridgeline intersects the central axis.

3. The light flux controlling member according to claim 2, wherein the plurality of ridges is disposed such that the ridgeline goes toward a front side as the ridgeline goes toward the central axis.

4. The light flux controlling member according to claim 2, wherein the plurality of ridges is disposed such that the ridgeline goes toward a rear side as the ridgeline goes toward the central axis.

5. A light-emitting device, comprising:
a light-emitting element; and
the light flux controlling member according to claim 1.

6. A surface light source device, comprising:
the light-emitting device according to claim 5; and
a light diffusion member configured to transmit light from the light-emitting device while diffusing the light.

7. A display device, comprising:
the surface light source device according to claim 6; and
a display member configured to be illuminated with light emitted from the surface light source device.
